(19) United States
(12) Patent Application Publication
(10) Pub. No.: US 2006/0291906 A1
(43) Pub. Date: Dec. 28, 2006

(54) Color image forming apparatus

(75) Inventor: Won-wook Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/350,124

(22) Filed: Feb. 9, 2006

(30) Foreign Application Priority Data
Jun. 23, 2005 (KR) 10-2005-0054385

(51) Int. Cl. G03G 15/01

(52) U.S. Cl. 399/223

(57) ABSTRACT

A color image forming apparatus includes a plurality of developers, an exposure unit forming a plurality of latent images on a photosensitive medium, and a power transmission unit simultaneously driving two of the developers that store toners having different polarities and colors. A charging unit converts toner images having different polarities, which are developed on the photosensitive medium, into toner images having the same polarity. The toner images are superpositionally transferred from the photosensitive medium to an intermediate transfer unit to form a color image.

### CROSS-REFERENCE TO RELATED PATENT APPLICATION

This application claims the benefit under 35 U.S.C. § 119(a) of Korean Patent Application No. 10-2005-0054385, filed on Jun. 23, 2005, in the Korean Intellectual Property Office, the entire disclosure of which is hereby incorporated by reference.

### BACKGROUND OF THE INVENTION

1. Field of the Invention

The present invention relates to a color image forming apparatus. More particularly, the present invention relates to a color image forming apparatus having a power transmission unit that simultaneously drives a plurality of developers.

2. Description of the Related Art

Generally, an electrophotographic color image forming apparatus forms a color image by applying light to a photosensitive medium charged to a predetermined potential to form a latent image thereon. The latent image is developed with toners of predetermined colors. The developed image is then transferred and fixed to a sheet of paper.

The colors of toners used for such a color image forming apparatus generally include yellow (Y), magenta (M), cyan (C), and black (K). Accordingly, four developing units are required for attaching four color toners to the latent image.

Techniques for forming a color image can be classified into single-pass techniques in which four exposure units and four photosensitive media are used, and multi-pass techniques in which an exposure unit and a photosensitive medium are used.

In a single-pass color image forming apparatus, the time necessary for color printing is equal to the time necessary for black and white printing. Therefore, the single pass technique is used mainly for a high-speed color image forming apparatus. However, since four exposure units and four photosensitive drums should be provided, this high-speed color image forming apparatus is expensive.

The color image forming apparatus working at a relatively low speed has a photosensitive drum and an exposure unit and uses the multi-pass technique, wherein the exposure, development, and transfer steps are repeated for each color to form a color toner image on an intermediate transfer medium, and the color toner image is transferred and fixed to a sheet of paper.

Four developers are sequentially activated in a multi-pass type image forming apparatus, such that a unit for sequentially transmitting power from a driving motor to the four developers is required. In the conventional image forming apparatus, the power is transmitted to the respective developers to develop an electrostatic latent image by using four clutches.

Recently, to increase the printing speed of the conventional multi-pass type image forming apparatus, a technique of simultaneously driving two developers to develop a plurality of electrostatic latent images has been introduced.

Thus, a unit for simultaneously transmitting the power from the driving motor to two developers is required. Accordingly, by simultaneously transmitting the power to two developers to drive the developers, a plurality of electrostatic latent images formed on a photosensitive drum is developed.

Accordingly, a need exists for an image forming apparatus that has an improved power transmission unit to simultaneously drive a plurality of developers.

### SUMMARY OF THE INVENTION

The present invention provides a color image forming apparatus having a power transmission unit that simultaneously transmits torque to two developers from a driving motor to develop a plurality of toner images.

According to an aspect of the present invention, a color image forming apparatus includes a plurality of developers, and a power transmission unit that simultaneously drives two developers.

The following relationship may be satisfied:
t₃≧t₁+t_{off},
where t₁=the total time for a first developer to perform a development operation, t_{off}=the absolute value of the time when the first developer finishes the development operation−the time when a second developer finishes a development operation, and t₃=the total time that a power transmission unit is turned on.

Additionally, the following relationship may be satisfied:
t₃≧t₂+tₒₙ,
where t₂=the total time for a second developer to perform a development operation, tₒₙ=the absolute value of the time when the first developer starts the development operation−the time when the second developer starts the development operation, and t₃=the total time that a power transmission unit is turned on.

The two developers that are simultaneously driven may store toners having different polarities, respectively.

According to another aspect of the present invention, a color image forming apparatus includes a plurality of developers and a power transmission unit that simultaneously drives two developers that store toners having different polarities and colors.

According to still another aspect of the present invention, a color image forming apparatus includes a plurality of developers, an exposure unit forming a plurality of latent images on a photosensitive medium, and a power transmission unit that simultaneously drives two developers that store toners having different polarities and colors. A charging unit converts toner images having different polarities, which are developed on the photosensitive medium, into toner images having the same polarity. A The toner images are superpositionally transferred from the photosensitive medium to an intermediate transfer unit to form a color image. The color image is formed through at least two development operations.

The charging unit may convert the toners having different polarities into toners having the same polarity without contacting the photosensitive medium.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a schematic diagram of a color image forming apparatus according to an exemplary embodiment of the present invention;

FIG. 2 is a schematic diagram illustrating power flow of a power transmission unit according to an exemplary embodiment of the present invention;

FIG. 3 is a perspective view of the power transmission unit according to an exemplary embodiment of the present invention;

FIG. 4 is an exploded perspective view of a spring clutch of FIG. 3;

FIG. 5 is a perspective view of a solenoid controlling the spring clutch of FIG. 4;

FIG. 6 is a schematic diagram illustrating operation of the spring clutch and the solenoid of FIGS. 4 and 5;

FIG. 7 is a diagram illustrating a state where two developers that store toners having different polarities and colors are selected; and

FIG. 8 is a schematic diagram illustrating a development principle according to an exemplary embodiment of the present invention.

Throughout the drawings, like reference numerals will be understood to refer to like parts, components and structures.

### DETAILED DESCRIPTION OF EXEMPLARY EMBODIMENTS

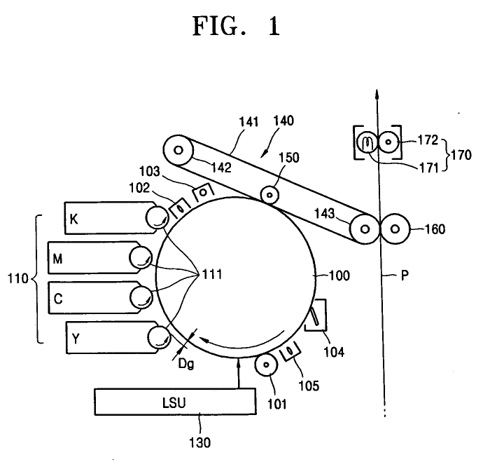

Referring to FIG. 1, an image forming apparatus includes a photosensitive drum 100, a plurality of developers 110, an intermediate transfer belt 141, a first transfer roller 150, a second transfer roller 160, and a fixing device 170.

The photosensitive drum 100 may be a cylindrical metal drum having a photoconductive layer formed on its outer circumferential surface. A photosensitive belt may be employed instead of the photosensitive drum 100.

A charger 101, a pre-transfer eraser 102, a charging unit 103, a photosensitive-drum cleaning unit 104, and a pre-charger eraser 105 are provided around the photosensitive drum 100.

The charger 101 charges the photosensitive drum 100 to a uniform potential and may include a charging roller or a corona charger. The charger 101 supplies electrical charges to the outer circumferential surface of the photosensitive drum 100 in a uniform potential while rotating either in contact with or not contacting the outer circumferential surface of the photosensitive drum 100.

The pre-transfer eraser 102 removes the electric charges from the portions (non-image area) other than the portions in which a toner image is formed on the photosensitive drum 100, before transferring the toner image on the photosensitive drum 100 to the transfer belt 131. The pre-transfer eraser 102 is optional.

The charging unit 103 converts the toner images having different polarities into toner images having the same polarity to transfer the toner images developed on the photosensitive drum 100 to the intermediate transfer unit 140. Preferably, the charging unit 103 is a corona charger. Since the contact of the charging unit 103 with the toner images may erase or deform the toner images, the toner images should be made to have the same polarity in a non-contact manner.

When a color image is formed by the use of the two-pass technique, the charging unit 103 is used for transferring the toner images to the intermediate transfer unit 140, which will be described in detail later.

The photosensitive-drum cleaning unit 104 serves to remove the toners that are not transferred to the intermediate transfer unit 140 from the photosensitive drum 100 and that remain on the photosensitive drum 100. The photosensitive-drum cleaning unit 104 may be a cleaning blade.

The pre-charger eraser 105 removes the electric charges from the whole surface of the photosensitive drum 100 before forming the toner images on the photosensitive drum 100.

The developers 110 contain powder-phase toners for yellow (Y), cyan (C), magenta (M), and black (K) colors, respectively, and are sequentially disposed in the rotational direction of the photosensitive drum 100 to be opposed to the photosensitive drum 100. The respective developers 110 include a development roller 111 that supplies toners to the electrostatic latent image formed on the photosensitive drum 100 to convert the latent image into a toner image. In the developers 110, the development roller 111 is provided at a development gap Dg from the outer circumferential surface of the photosensitive drum 110. The development gap Dg is preferably several tens to several hundreds of microns.

The exposure unit 130 is provided below the photosensitive drum 110 and radiates light to the photosensitive drum 110 charged to a uniform potential to form an electrostatic latent image thereon.

The intermediate transfer unit 140 includes a transfer belt 141 and support rollers 142 and 143 supporting and circulating the transfer belt 141. The transfer belt 141 is opposed to the photosensitive drum 100 by means of a first transfer roller 150 between the support roller 142 and the support roller 143, whereby the toner images are transferred to the transfer belt 141 from the photosensitive drum 100.

The traveling speed of the transfer belt 141 is preferably substantially equal to the rotational speed of the photosensitive drum 100. The length of the transfer belt 141 should be approximately equal to or greater than the length of a sheet of paper P on which a color toner image is finally received.

The transfer roller 160 is opposed to the transfer belt 141. The transfer roller 160 is separated from the transfer belt 141 while the color toner image is transferred to the transfer belt 141 from the photosensitive drum 100. When the color toner image is completely transferred to the transfer belt 141, the transfer roller 160 comes in contact with the transfer belt 141 with a predetermined pressure to transfer the color toner image to the sheet of paper P.

The fixing device 170 includes a heating roller 171 emitting heat and a pressing roller 172 pressing the sheet of paper P onto the heating roller 171 while rotating with the heating roller 171, which is opposed thereto with a predetermined pressure. The fixing device 170 fuses and fixes the color toner image to the sheet of paper P by applying heat and pressure to the color toner image. The fixing device 170 may include a heating roller instead of the pressing roller 172.

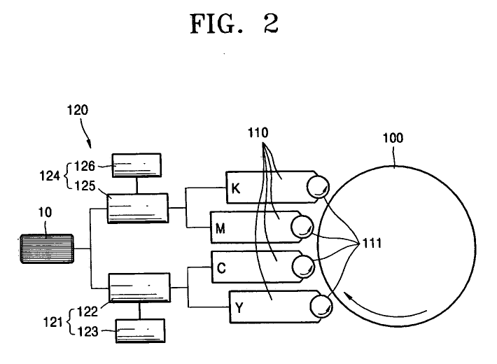

Referring to FIG. 2, the power transmission unit 120 simultaneously transmits power to two developers, which form a group, and includes a first power transmission unit 121 and a second power transmission unit 124.

The power transmission unit 120 transmits power to the developers from a driving source by the forward or backward rotation of a driving motor, a swing gear, and a clutch. A structure by which power is transmitted to the developers by the use of a plurality of clutches will be described.

The structure employing a plurality of clutches is only an example, and a variety of other examples having the same function may be used.

The first power transmission unit 121 includes a first clutch 122 and a first control unit 123. The first clutch 122 is connected to two developers 110Y and 110C. The second power transmission unit 124 includes a second clutch 125 and a second control unit 126. The second clutch 125 is connected to two developers 110M and 110K.

The first clutch 122 and the second clutch 125 are connected to the driving source 10. Accordingly, when the driving source 10 is activated, the first clutch 122 and the second clutch 125 are simultaneously driven.

The first control unit 123 and the second control unit 126 are solenoids controlling operations of the first clutch 122 and the second clutch 125, respectively. When controlling the developers 110Y and 110C, the first control unit 123 controls the first clutch 122 so as not to transmit power of the driving source 10 to the developers 110M and 110K.

When controlling the developers 110M and 110K, the second control unit 126 controls the second clutch 125 so as not to transmit power of the driving source 10 to the developers 110Y and 110C.

Even when the developers 110Y and 110C are simultaneously activated by the use of the first clutch 122, the first clutch 122 is deactivated not at the time point when the developer 110Y finishes the development but at the time point when the developer 110C finishes the development because the developers 110Y and 110C are spaced from each other by a predetermined distance.

Here, suppose that t₁=total time for a first developer to perform a development operation,
t₂=the total time for a second developer to perform a development operation,
tₒₙ=the absolute value of the time when the first developer starts the development operation−the time when the second developer starts the development operation,
t_{off}=the absolute value of the time when the first developer finishes the development operation−the time when the second developer finishes the development operation, and
t₃=the total time that the first clutch is turned on,

The following relationship is then satisfied:
t₃≧t₁+t_{off} or t₃≧t₂+tₒₙ.

The first developer indicates the developer that is first selected in the rotation direction of the photosensitive drum 100 and the second developer indicates the developer that is second selected in the rotational direction of the photosensitive direction 100.

For example, when the developers 110Y and 110C are selected, the first developer indicates the developer 110Y and the second developer indicates the developer 110C. When the developers 110M and 110K are selected, the first developer indicates the developer 110M and the second developer indicates the developer 110K.

Therefore, the first clutch 122 is turned off not at the time when the first developer finishes the development operation, but at the time when the second developer finishes the development operation.

This is because the second developer cannot develop the electrostatic latent image corresponding to the distance to the first developer when the first clutch 122 is turned off at the time when the first developer finishes the development operation.

The operation of simultaneously activating two developers to develop the electrostatic latent images formed on the photosensitive drum 100 will be described later.

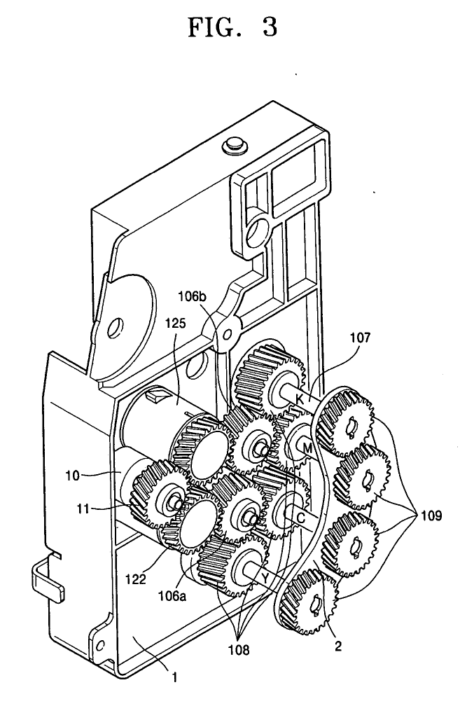

FIGS. 3 to 6 show an example of the power transmission unit and explain the operational relationship between the clutches and the control units. The present invention is not limited to the shown example, but may be modified in various forms.

Referring to FIG. 3, four intermediate gears 108 and four driving gears 109 connected to each other through driving axes 107 are disposed inside a main frame 1. One end of each driving axis 107 is supported by the main frame 1 and the other end is supported by a bracket 2 so as to be rotatable. The developers 110Y, 110C, 110M, and 110K are connected to the driving gears 109, respectively, so as to transmit power thereto.

The first clutch 122 and the second clutch 125 are connected to a gear 11 connected to a driving motor 10, which is a driving source. The first clutch 122 is connected to the intermediate gears 108Y and 108C through a first connection gear 106a and the second clutch 125 is connected to the intermediate gears 108M and 108K through a second connection gear 106b.

The first clutch 122 and the second clutch 125 are connected to the first control unit 123 and the second control unit 126, respectively, so as to control the power transmission thereto. The first control unit 123 and the second control unit 126 are not shown in FIG. 3 for the purpose of simplification of the figure and the operational relationship of the first clutch 122, the second clutch 125, the first control unit 123, and the second control unit 126 is shown in FIG. 6, which is described later. A spring clutch is exemplified as the clutches and a solenoid is exemplified as the control units.

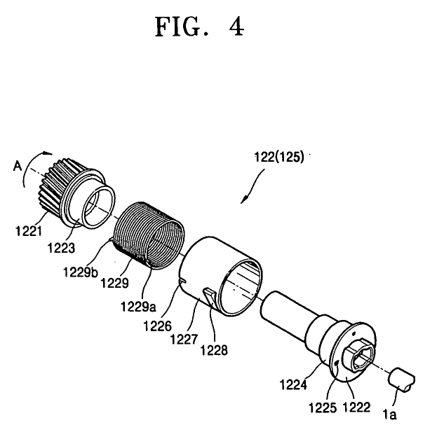

Referring to FIG. 4, the spring clutch 120 includes a clutch gear 1221, a clutch spring 1229, a clutch hub 1227, and a bushing 1222.

The bushing 1222 is fixed to one end 1a of the main frame 1 and the clutch gear 1221 is rotatably coupled to the bushing 1222.

The clutch spring 1229 is inserted into cylindrical portions 1223 and 1224 of the clutch gear 1221 and the bushing 1222, respectively. The clutch hub 1227 surrounds the clutch spring 1229. The clutch hub 1227 is provided with a coupling portion 1228.

One end 1229a and the other end 1229b of the clutch spring 1229 are inserted into insertion holes 1225 and 1226 provided in the bushing 1222 and the clutch hub 1227, respectively. The clutch gear 1221 connected to the gear 11 is rotated by the driving motor 10.

The driving motor 10 rotates the clutch gear 1221 in the direction indicated by the arrow A. The clutch spring 1229 strongly tightens around the cylindrical portions 1223 and 1224 of the clutch gear 1221 and the bushing 1222 while being twisted in the direction in which the inner diameter of the clutch spring 1229 decreases. Therefore, when the clutch gear 1221 rotates in the direction indicated by the arrow A, the clutch spring 1229 and the bushing 1222 rotate. Since the other end 1229b of the clutch spring 1229 is inserted into the insertion hole 1226 of the clutch hub 1227, the clutch hub 1227 is also rotated.

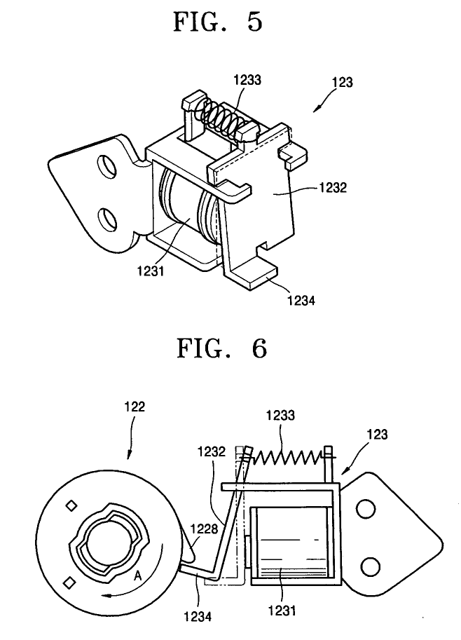

Referring to FIGS. 5 and 6 the solenoid 123 includes a coil part 1231, a moving piece 1232, and a spring 1233. An end of the moving piece 1232 is provided with a fitting protrusion 1234.

When the coil part 1231 is supplied with current, the moving piece 1232 comes in contact with the coil part 1231 as indicated by a dotted line. When the current supply is interrupted, the moving piece 1232 is restored to the position indicated by a solid line by an elastic force of the spring 1233.

Referring to FIGS. 4 and 6, in the state where the current is not supplied to the coil part 1231, the fitting protrusion 1234 of the moving piece 1232 moves as indicated by the solid line in FIG. 6 and comes in contact with the coupling portion 1228 to prevent the rotation of the clutch hub 1227.

Since the other end 1229b of the clutch spring 1229 is inserted into the insertion hole 1226 of the clutch hub 1227, the clutch spring 1229 twists in the direction in which the inner diameter thereof increases if the clutch hub 1227 does not rotate.

Then, the tightening force of the clutch spring 1229 to the cylindrical portion 1223 of the clutch gear 1221 is weakened and the inner circumferential portion of the clutch spring 1229 and the cylindrical portion 1223 of the clutch gear 1221 slide with respect to each other, thereby preventing the rotation of the clutch spring 1229 and the bushing 1222. Accordingly, the first connection gear 106a and the second connection gear 106b do not rotate.

When current is supplied to the coil part 1231, the moving piece 1232 comes in contact with the coil part 1231 as indicated by the dotted line in FIG. 6 and the fitting protrusion 1234 is separated from the coupling portion 1228. Then, when the clutch gear 1221 rotates as described above, the first connection gear 106a or the second connection gear 106b rotates.

As described above, by selectively controlling the first clutch 122 and the second clutch 125 by the use of the first control unit 123 and the second control unit 126, the developers 100Y and 100C and the developers 100M and 100K may be driven.

Next, a method of developing a plurality of electrostatic latent images formed on the photosensitive drum by simultaneously driving a plurality of developers is described.

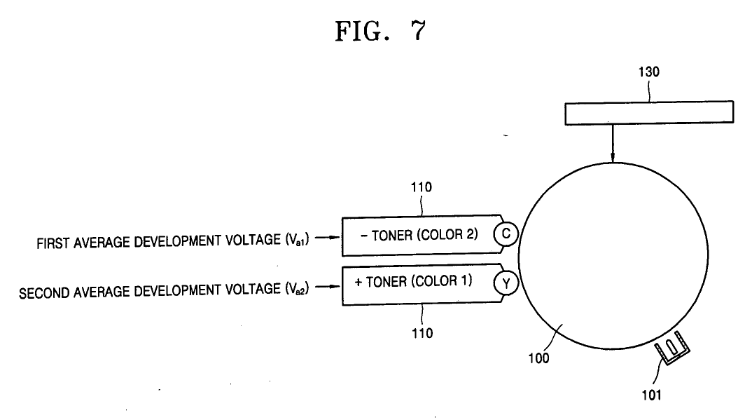

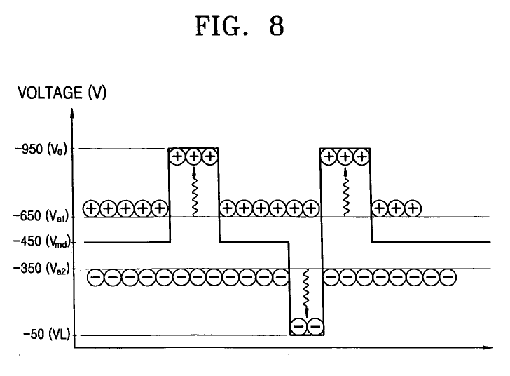

FIG. 7 is a diagram illustrating a state where two developers that store toners having different polarities and colors are selected. FIG. 8 is a schematic diagram illustrating a development principle according to an exemplary embodiment of the present invention.

First, three levels of potentials (level 1, level 2, and level 3) are provided to the photosensitive drum 100 by the exposure unit 130.

For example, at level 1, a latent image potential V_{L} with which a toner image may be formed by means of toners having negative (−) charges is provided to the photosensitive drum 100. At level 2, a non-latent image potential V_{md} with which an image is not formed is provided to the photosensitive drum 100. At level 3, a surface potential V₀ with which a toner image is formed by means of toners having positive (+) charges is provided to and maintained on the photosensitive drum 100.

The absolute values of the surface potential V₀, the non-latent image potential V_{md}, and the latent image potential V_{L} preferably satisfy the following relationship: |surface potential V₀|>|non-latent image potential V_{md}|>|latent image potential V_{L}|. For example, the surface potential V₀ is approximately −950V, the non-latent image potential V_{md} is in the range of −400V to −550V, preferably approximately −450V, and the latent image potential V_{L} is in the range of −30V to −150V, preferably approximately −50V.

Thus, the photosensitive drum 100 is exposed to the light radiated from the exposure unit 130 to have three levels of potentials such as image areas in which images are formed by two colors having different polarities and a non-image area in which no image is formed.

Referring to FIGS. 7 and 8, the toner (for example, yellow Y or magenta M) having a positive (+) polarity is transferred to the photosensitive drum 100 from the developing roller 111 in an electrostatic development manner to develop the electrostatic latent images into toner images.

First, the toner having a positive (+) polarity is transferred to an image area of the photosensitive drum 100 in which the surface potential V₀ is maintained by the exposure unit 130 controlled at the third level.

Here, the development condition preferably satisfies the following condition:
   |surface potential V₀|−|first average development potential Vₐ₁|>|first average development potential Vₐ₁|−|non-latent image potential V_{md}|, where the first average development potential Vₐ₁ indicates a voltage applied to the toner having a positive (+) polarity.

For example, when the surface potential V₀=−950V, the first average development potential Vₐ₁=−650V, and the non-latent image potential V_{md}=450V, the yellow toner Y that is charged with the first average development potential Vₐ₁ and that has a positive (+) polarity has a greater electrostatic force with respect to the surface potential V₀ than that with respect to the non-latent image potential V_{md}. Accordingly, the yellow toner Y is attracted to the image area charged with the surface potential V₀. Therefore, the yellow color Y having a positive (+) polarity is developed in the image area charged with the surface potential V₀. Preferably, the first average development potential Vₐ₁ is applied as a voltage in which a DC voltage and an AC voltage are superposed on each other.

Next, the toner (for example, cyan C or black K) having a negative (−) polarity is transferred to the photosensitive drum 100 from the developing roller 111 in an inverted development manner to develop the toner image.

The toner having a negative (−) polarity is transferred to an image area of the photosensitive drum 100 in which the latent image potential V_{L} is maintained by the exposure unit 130 controlled in level 1.

The development condition preferably satisfies the following condition: |surface potential V₀|−|non-latent image potential V_{md}|>|second average development potential Vₐ₂|−|latent image potential V_{L}|.

For example, when the surface potential V₀=−950V, the second average development potential Vₐ₂=−350V, and the latent image potential Vₗ=−50V, the cyan toner C that is charged with the second average development potential Vₐ₂ and that has a negative (−) polarity does not move to the non-image area because the electric force acting on the non-image area having the non-latent image potential V_{md} more greatly acts toward the developing roller 111. The cyan toner C that is charged with the second average development potential Vₐ₂ and that has a negative (−) polarity moves to the image area having the latent image potential V_{L} to form the electrostatic latent image because the electric force acting on the image area having the latent image potential Vₗ more greatly acts toward the photosensitive drum 100. Therefore, the cyan color C having a negative (−) polarity is developed in the image area charged with the latent image potential V_{L}. Preferably, the second average development potential Vₐ₂ is applied as a voltage in which a DC voltage and an AC voltage are superposed on each other.

Thus, the image area charged with the surface potential V₀ is developed with the toner having a positive (+) polarity, the image area charged with the latent image potential Vₗ is developed with the toner having a negative (−) polarity, and the non-image area charged with the non-latent image potential V_{md} is not developed into an image.

Here, the developers 110Y and 110C are driven by means of the power supplied from the first connection gear 106a connected to the first clutch 122, as shown in FIG. 3, and the developing rollers 111Y and 111C rotate in contact with the outer circumferential surface of the photosensitive drum 100.

Since the second clutch 125 is controlled by the second control unit 126, the developers 110M and 110K are not activated.

Next, an operation in which toners having different polarities are transferred to the transfer belt 141 from the photosensitive drum 100 is described.

By the use of attraction based on different polarities, a plurality of toner images developed with toners having different polarities and colors are transferred to the transfer belt 141 from the photosensitive drum. A “first transfer” denotes toner images transferred to the transfer belt 141 from the photosensitive drum 100.

That is, when a negative (−) voltage is applied to the transfer belt 141, the toner images developed on the photosensitive drum 100 have a positive (+) polarity.

Toner images having a positive (+) polarity and toner images having a negative (−) polarity exist on the photosensitive drum 100. The toner images having a positive (+) polarity may be transferred to the transfer belt 141 from the photosensitive drum 100, but the toner images having a negative (−) polarity cannot be transferred thereto.

Accordingly, the corona discharge is generated by applying a positive voltage to the charging unit 103 and constant current is applied to the photosensitive drum 100, thereby converting the toners having different polarities into toners having a positive (+) polarity. This is referred to as toner polarity identification.

As a result, by applying a negative voltage to the intermediate transfer unit 140, the toners having the positive (+) polarity on the photosensitive drum 100 are transferred to the transfer belt 141 from the photosensitive drum 100.

Although the toners having different polarities are converted into toners having a positive (+) polarity in the above-mentioned exemplary embodiment, the toners having different polarities may be converted into toners having a negative (−) polarity.

In the color image forming apparatus according to exemplary embodiments of the present invention described above, a latent image is developed at low cost by simultaneously driving two developers.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A color image forming apparatus, comprising:
a plurality of developers; and
a power transmission unit simultaneously driving two of the developers.

2. The color image forming apparatus according to claim 1, wherein
the color image forming apparatus has four developers, the power transmission unit being adapted to simultaneously drive at least one of the two pairs of developers.

3. The color image forming apparatus according to claim 2, wherein
a first clutch is connected between the first pair of developers and a driving motor of the power transmission unit; and
a second clutch is connected between the second pair of developers and the driving motor, the first and second clutches controlling power transmission to the first and second pairs of developers.

4. The color image forming apparatus according to claim 1, wherein the following relationship is satisfied
t₃≧t₁+t_{off},
where
t₁ is a total time for a first developer to perform a development operation,
t_{off} is an absolute value of a time when the first developer finishes the development operation−a time when a second developer finishes a development, and
t₃ is a total time that the power transmission unit is turned on.

5. The color image forming apparatus according to claim 1, wherein the following relationship is satisfied
t₃≧t₂+tₒₙ,
where
t₂ is a total time for a second developer to perform a development operation,
tₒₙ is an absolute value of a time when a first developer starts a development operation−a time when the second developer starts the development operation, and
t₃ is a total time that the power transmission unit is turned on.

6. The color image forming apparatus according to claim 1, wherein
the two developers that are simultaneously driven store toners having different polarities, respectively.

7. A color image forming apparatus, comprising:
a plurality of developers; and
a power transmission unit that simultaneously drives two of the developers that store toners having different polarities and colors.

8. The color image forming apparatus according to claim 7, wherein
the color image forming apparatus has four developers, the power transmission unit being adapted to simultaneously drive one of the two pairs of developers.

9. The color image forming apparatus according to claim 8, wherein
a first clutch is connected between the first pair of developers and a driving motor of the power transmission unit; and
a second clutch is connected between the second pair of developers and the driving motor, the first and second clutches controlling power transmission to the first and second pairs of developers

10. The color image forming apparatus according to claim 7, wherein the following relationship is satisfied
t₃≧t₁+t_{off},
where
t₁ is a total time that a first developer performs a development operation,
t_{off} is an absolute value of a time when the first developer finishes the development operation−a time when a second developer finishes a development operation, and
t₃ is a total time that the power transmission unit is turned on.

11. The color image forming apparatus according to claim 7, wherein the following relationship is satisfied:
t₃≧t₂+tₒₙ,
where
t₂ is a total time for a second developer to perform a development operation,
tₒₙ is an absolute value of a time when a first developer starts a development operation−a time when the second developer starts the development operation, and
t₃ is a total time that the power transmission unit is turned on.

12. A color image forming apparatus, comprising:
a plurality of developers;
an exposure unit forming a plurality of latent images on a photosensitive medium;
a power transmission unit simultaneously driving two of the developers that store toners having different polarities and colors;
a charging unit converting toner images having different polarities that are developed on the photosensitive medium into toner images having the same polarity; and
an intermediate transfer unit to which the toner images are superpositionally transferred from the photosensitive medium to form a color image,
wherein the color image is formed through at least two development operations.

13. The color image forming apparatus according to claim 12, wherein
the color image forming apparatus has four developers, the power transmission unit being adapted to simultaneously drive one of the two pairs of developers.

14. The color image forming apparatus according to claim 13, wherein
a first clutch is connected between the first pair of developers and a driving motor of the power transmission unit; and
a second clutch is connected between the second pair of developers and the driving motor, the first and second clutches controlling power transmission to the first and second pairs of developers

15. The color image forming apparatus according to claim 12, wherein the following relationship is satisfied:
t₃≧t₁+t_{off},
where
t₁ is a total time for a first developer to perform a development operation,
t_{off} is an absolute value of a time when the first developer finishes the development operation−a time when a second developer finishes a development operation, and
t₃ is a total time that the power transmission unit is turned on.

16. The color image forming apparatus according to claim 12, wherein the following relationship is satisfied:
t₃≧t₂+tₒₙ,
where
t₂ is a total time for a second developer to perform a development operation,
tₒₙ is an absolute value of a time when a first developer starts a development operation−a time when the second developer starts the development operation, and
t₃ is a total time wherein the power transmission unit is turned on.

17. The color image forming apparatus according to claim 12, wherein
the charging unit converts the toners having different polarities into toners having the same polarity without contacting the photosensitive medium.
